(19) United States
(12) Patent Application Publication
(10) Pub. No.: US 2026/0112758 A1
(43) Pub. Date: Apr. 23, 2026

(54) SUB-BATTERY PACK STRUCTURE

(71) Applicants: Hyundai Motor Company, Seoul (KR); Kia Corporation, Seoul (KR)

(72) Inventors: Se Gi Kang, Hwaseong (KR); Hyeon Su Jin, Hwaseong (KR); Beom Sik Park, Hwaseong (KR)

(21) Appl. No.: 19/071,532

(22) Filed: Mar. 5, 2025

(30) Foreign Application Priority Data
Oct. 17, 2024 (KR) 10-2024-0142238

(51) Int. Cl. H01M 50/262; H01M 50/204; H01M 50/242; H01M 50/271

(52) U.S. Cl. CPC H01M 50/262; H01M 50/204; H01M 50/242; H01M 50/271; H01M 2220/20

(57) ABSTRACT

Provided are sub-battery packs stacked in a lower casing. Each pack includes a sub-pack casing with grippers protruding from two opposite side surfaces, which compress a downward-bent cover flange. This arrangement helps suppress vibration and prevent noise. In a multi-layer setup, the bottom pack lacks grippers, while the upper packs have them only on their casings. The grippers provide holder insertion holes for easy assembly, allowing the packs to be lifted and placed accurately into the lower casing.

### CROSS-REFERENCE TO RELATED APPLICATION

The present application claims under 35 U.S.C. § 119(a) the benefit of Korean Patent Application No. 10-2024-0142238, filed on Oct. 17, 2024, the entire contents of which are incorporated herein for all purposes by this reference.

### BACKGROUND OF THE DISCLOSURE

### Technical Field

The present disclosure relates to a battery pack capable of being used for an electric vehicle or the like, and more particularly, to a technology related to a sub-battery pack structure capable of constituting a battery pack by coupling a plurality of sub-battery pack structures.

### Background

An electric vehicle or the like is equipped with a motor configured to generate driving power for the vehicle, and a battery pack configured to supply electric power to be provided to the motor.

The battery pack may include therein a plurality of battery cells, and the battery cells may be mounted in the form of a battery module in the battery pack.

In addition, the battery pack may include a plurality of sub-battery packs configured to accommodate a plurality of battery cells therein.

The foregoing explained as the background is intended merely to aid in the understanding of the background of the present disclosure, and is not intended to mean that the present disclosure falls within the purview of the related art that is already known to those skilled in the art.

### SUMMARY OF THE DISCLOSURE

The present disclosure is proposed to solve these problems and aims to provide a sub-battery pack structure and a battery pack, in which sub-battery packs, which constitute the battery pack, may be easily and stably assembled to a lower casing, vibration of an upper cover of the sub-battery pack may be effectively suppressed while a vehicle travels, and rattle noise may be prevented.

Technical problems to be solved by the present disclosure are not limited to the above-mentioned technical problems, and other technical problems, which are not mentioned above, may be clearly understood from the following descriptions by those skilled in the art to which the present disclosure pertains.

In order to achieve the above-mentioned object, the present disclosure provides a sub-battery pack structure including: a sub-pack casing configured to form an external appearance of a sub-battery pack; and grippers mounted to protrude from two opposite surfaces of the sub-pack casing that face each other.

Each of the grippers may be mounted on a lateral surface of the sub-pack casing and elongated in a horizontal direction of the sub-pack casing.

Each of the grippers may have a holder insertion hole into which a holding device configured to hold and move the sub-battery pack is inserted.

Each of the grippers may be mounted on the sub-pack casing in a state in which each gripper compresses a part of an upper cover of the sub-pack casing against a lateral surface of the sub-pack casing.

The upper cover of the sub-pack casing may have a cover flange having two opposite ends bent downward, and each of the grippers may be mounted in the state in which each gripper compresses the cover flange against the lateral surface of the sub-pack casing.

A pop bolt, which protrudes while penetrating the cover flange, may be provided on the lateral surface of the sub-pack casing, and each of the grippers may be inserted into the pop bolt and fixed in the state in which each gripper compresses the cover flange against the lateral surface of the sub-pack casing by a gripper locking nut fastened to the pop bolt.

A tool insertion groove, which allows a tool to pass therethrough in an upward/downward direction of each gripper, may be formed in each of the grippers while avoiding a portion penetrated by the pop bolt.

The grippers may be mounted on two opposite surfaces of the sub-battery pack and mounted symmetrically at a center based on a horizontal longitudinal direction.

The grippers may be asymmetrically mounted on two opposite surfaces of the sub-battery pack while avoiding a venting valve or a busbar provided on the lateral surface of the sub-battery pack.

The sub-battery packs may overlap one another in an upward/downward direction, and each of the grippers may be mounted only on a lateral surface of the second layer sub-battery pack when a first layer sub-battery pack, which is positioned at a lowermost side, and a second layer sub-battery pack, which overlaps an upper side of the first layer sub-battery pack, are coupled to each other in the upward/downward direction.

The grippers mounted on the lateral surface of the second layer sub-battery pack may be mounted on two opposite surfaces of the second layer sub-battery pack and mounted symmetrically at a center based on a horizontal longitudinal direction, a third layer sub-battery pack may overlap an upper side of the second layer sub-battery pack, and the grippers mounted on the lateral surface of the third layer sub-battery may be asymmetrically mounted on two opposite surfaces of the third layer sub-battery pack while avoiding a venting valve or a busbar provided on the lateral surface of the third layer sub-battery pack.

In addition, in order to achieve the above-mentioned object, the present disclosure provides a battery pack including: a lower casing opened upward to accommodate a plurality of sub-battery packs; a plurality of sub-battery packs stacked on the lower casing from above, each sub-battery pack including a sub-pack casing configured to form an external appearance of the sub-battery pack; and grippers mounted to protrude from two opposite surfaces of at least one sub-pack casing among the plurality of sub-battery packs, the two opposite surfaces facing each other.

Among the sub-battery packs, a first layer sub-battery pack, which is provided at a lowermost side, and a second layer sub-battery pack, which overlaps an upper side of the first layer sub-battery pack, may be coupled to each other in an upward/downward direction and loaded into the lower casing, and each of the grippers may be mounted on the sub-pack casing of the second layer sub-battery pack but not on the first layer sub-battery pack.

Each of the grippers may also be mounted on a sub-pack casing of a third layer sub-battery pack when the third layer sub-battery pack overlaps an upper side of the second layer sub-battery pack.

Each of the grippers may be mounted on a lateral surface of the sub-pack casing and elongated in a horizontal direction of the sub-pack casing.

The upper cover of the sub-pack casing may have a cover flange having two opposite ends bent downward, and each of the grippers may be mounted in the state in which the each gripper compresses the cover flange against the lateral surface of the sub-pack casing.

A pop bolt, which protrudes while penetrating the cover flange, may be provided on the lateral surface of the sub-pack casing, a mounting hole penetrated by the pop bolt may be formed in each of the grippers, and a gripper locking nut may be fastened to the pop bolt so that each of the grippers compresses the cover flange against the lateral surface of the sub-pack casing.

A tool insertion groove, which allows a tool to pass therethrough in an upward/downward direction of each gripper, may be formed in each of the grippers while avoiding a portion penetrated by the pop bolt.

A holder insertion hole may be formed in each of the grippers while avoiding the portion penetrated by the pop bolt and a portion having the tool insertion groove, and a holding device configured to hold and move the sub-battery pack may be inserted into the holder insertion hole.

According to the sub-battery pack structure of the present disclosure, the sub-battery packs, which constitute the battery pack, may be easily and stably assembled to the lower casing, the vibration of the upper cover of the sub-battery pack may be suppressed while the vehicle travels, and the rattle noise may be effectively prevented.

In some embodiments, a battery pack includes a lower casing that is opened upward to accommodate multiple sub-battery packs stacked from above. Each sub-battery pack has a sub-pack casing forming its external appearance and grippers that protrude from two opposite surfaces of the sub-pack casing, those surfaces facing each other. Among these sub-battery packs, a first layer sub-battery pack is provided at a lowermost side, and a second layer sub-battery pack overlaps an upper side of the first layer sub-battery pack, with both being coupled in an upward/downward direction and loaded into the lower casing. In this arrangement, each of the grippers is mounted only on the sub-pack casing of the second layer sub-battery pack. Moreover, each gripper is mounted on a lateral surface of the sub-pack casing and elongated in a horizontal direction. The upper cover of the sub-pack casing has a cover flange bent downward at two opposite ends, and the grippers compress that cover flange against the lateral surface of the sub-pack casing.

As discussed, the method and system suitably include use of a controller or processer.

In another embodiment, vehicles are provided that comprise an apparatus as disclosed herein.

The effects obtained by the present disclosure are not limited to the aforementioned effects, and other effects, which are not mentioned above, will be clearly understood by those skilled in the art from the following description.

### BRIEF DESCRIPTION OF THE DRAWINGS

FIG. 1 is an exploded perspective view of a battery pack according to an embodiment.

FIG. 2 is a view for explaining a state made immediately before a gripper is coupled in a state in which a first layer sub-battery pack and a second layer sub-battery pack in FIG. 1 are coupled while overlapping each other upward and downward.

FIG. 3 is a view for explaining a state made immediately before the gripper is coupled to a third layer sub-battery pack in FIG. 1.

FIG. 4 is a detailed view illustrating a state in which the gripper is coupled to the third layer sub-battery pack in FIG. 3.

FIG. 5 is a top plan view illustrating a state in which the first layer sub-battery pack and the second layer sub-battery pack are coupled while overlapping each other upward and downward when viewed from above.

FIG. 6 is an observation view illustrating the first layer sub-battery pack and the second layer sub-battery pack in FIG. 5 in direction VI.

FIG. 7 is an observation view illustrating the first layer sub-battery pack and the second layer sub-battery pack in FIG. 5 in direction VII.

FIG. 8 is a top plan view for explaining a state in which the third layer sub-battery pack is seated on an upper side of an intermediate support provided above the second layer sub-battery pack.

FIG. 9 is an observation view illustrating the third layer sub-battery pack in FIG. 8 in direction IX.

FIG. 10 is an observation view illustrating the third layer sub-battery pack in FIG. 8 in direction X.

FIG. 11 is a view for explaining a state in which a holder is coupled to the gripper of the sub-battery pack.

FIG. 12 is a view for explaining a state in which a plurality of sub-battery packs is loaded into a lower casing.

### DETAILED DESCRIPTION OF THE DISCLOSURE

In the description of the embodiments disclosed in the present specification, the specific descriptions of publicly known related technologies will be omitted when it is determined that the specific descriptions may obscure the subject matter of the embodiments disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

In the present specification, the terms “comprises,” “comprising,” “includes,” “including,” “containing,” “has,” “having” or other variations thereof are inclusive and therefore specify the presence of stated features, integers, steps, operations, elements, components, and/or combinations thereof, but do not preclude the presence or addition of one or more other features, integers, steps, operations, elements, components, and/or combinations thereof.

In any configuration among the configurations disclosed in the present specification, any number of components or various components may be included in the present disclosure disclosed in the present specification. The components may include any combination of the features disclosed in the present specification and be arranged in any configuration among various configurations disclosed in the present specification. The concepts related to the use and operations of the components of the present disclosure, as well as the structure and arrangement of the components of the present disclosure, may be applied not only to particular embodiments discussed in the present specification but also to any number of embodiments in any combination. The embodiments including various features of various arrangements will be described below with reference to the drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, various embodiments disclosed in the present specification will be described in detail with reference to the accompanying drawings. The same or similar constituent elements are assigned with the same reference numerals regardless of reference numerals, and the repetitive description thereof will be omitted.

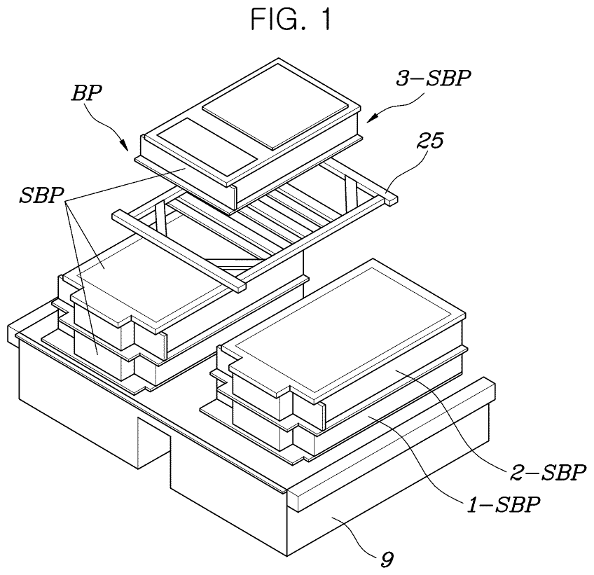

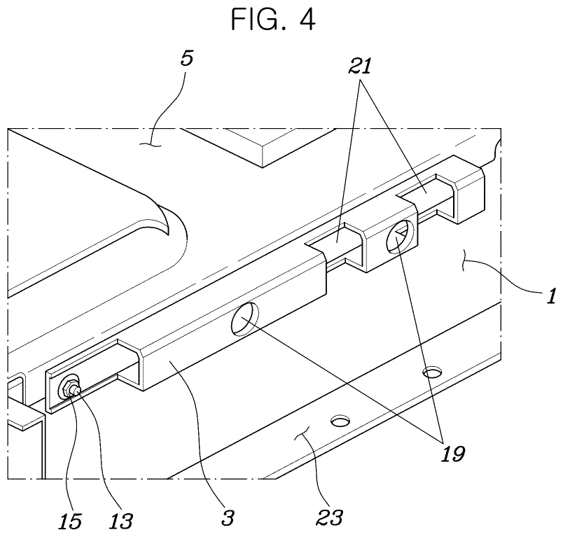

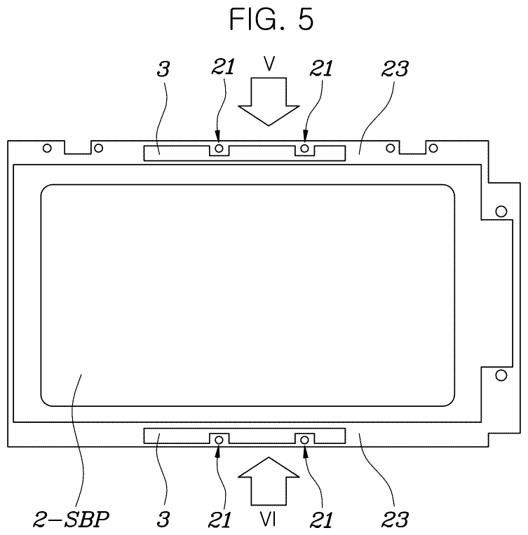

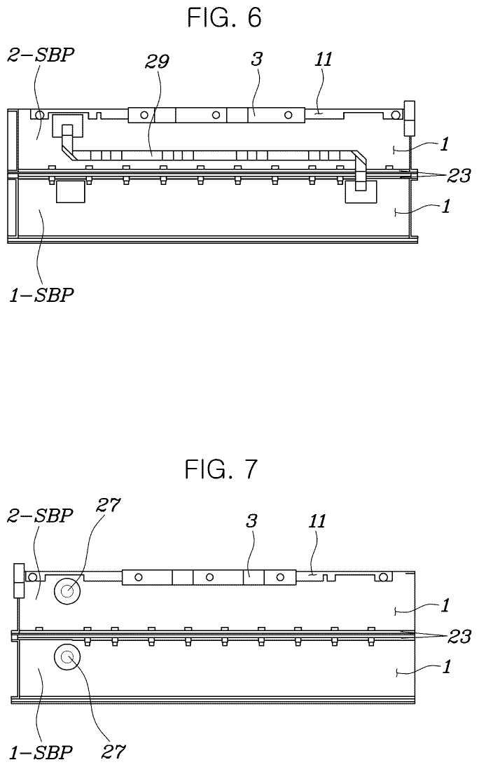

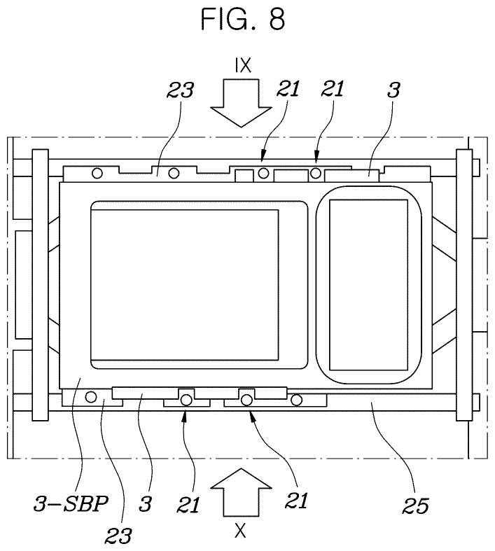

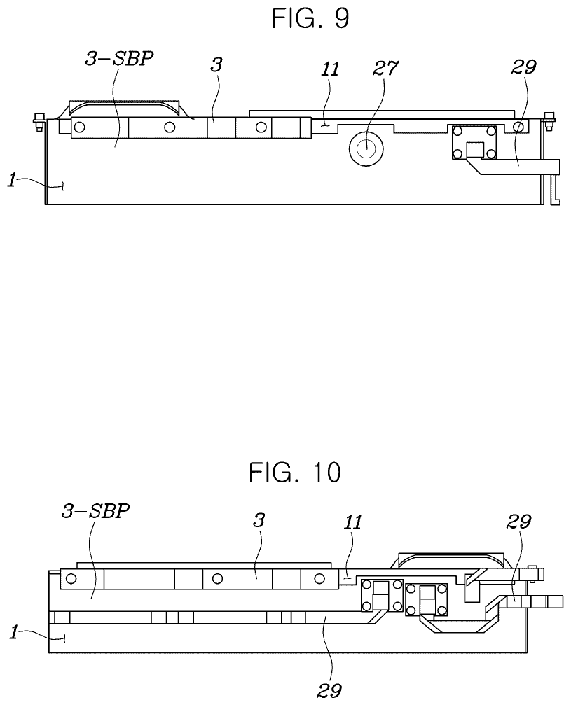

With reference to FIGS. 1 to 12, a sub-battery pack structure of the present disclosure includes a sub-pack casing 1 configured to form an external appearance of a sub-battery pack SBP, and grippers 3 mounted to protrude from two opposite surfaces of the sub-pack casing 1 that face each other.

In FIGS. 1 to 3, a first layer sub-battery pack 1-SBP, a second layer sub-battery pack 2-SBP, and a third layer sub-battery pack 3-SBP are collectively called the sub-battery pack SBP. A plurality of battery cells is accommodated in the sub-pack casing 1, and an upper cover 5 to be described below is provided above the sub-battery pack SBP.

That is, the sub-battery pack structure of the present disclosure is configured such that the grippers 3 are respectively provided on two opposite surfaces of the sub-battery pack SBP that defines the sub-pack casing 1.

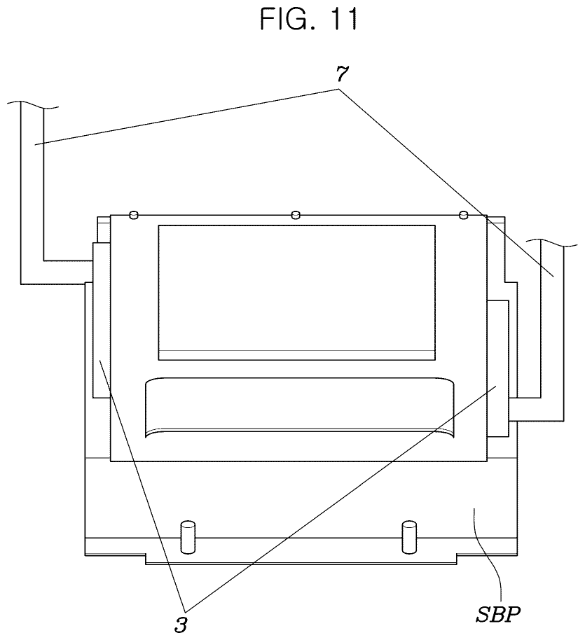

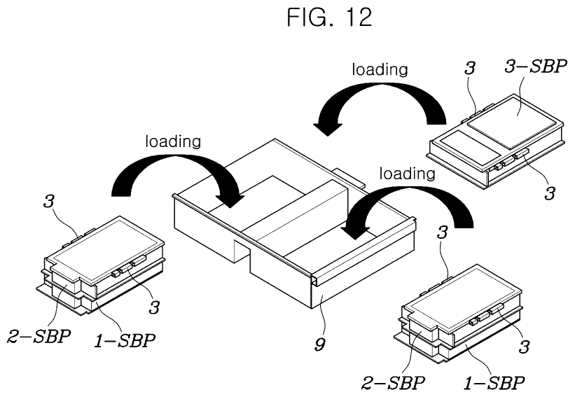

Therefore, as illustrated in FIG. 11, the sub-battery pack SBP may move in a three-dimensional space in a state in which the sub-battery pack SBP is held by a holding device 7 configured to hold the grippers 3 at two opposite sides. As illustrated in FIG. 12, the holding device 7 may assemble the sub-battery pack SBP by loading the sub-battery pack SBP into a lower casing 9, which constitutes a battery pack BP, from above.

For reference, the holding device 7 may be configured as a hoist device, a robot, or the like in the related art.

The gripper 3 is mounted on the sub-pack casing 1 in a state in which the gripper 3 compresses a part of the upper cover 5 of the sub-pack casing 1 against a lateral surface of the sub-pack casing 1.

That is, the upper cover 5 of the sub-pack casing 1 has a cover flange 11 having two opposite ends bent downward. The gripper 3 is mounted in the state in which the gripper 3 compresses the cover flange 11 against the lateral surface of the sub-pack casing 1.

Specifically, pop bolts 13 are provided on the lateral surface of the sub-pack casing 1 and protrude while penetrating the cover flange 11. The cover flange 11 of the upper cover 5 is assembled to be in surface contact with the lateral surface of the sub-pack casing 1 in the state in which the pop bolt 13 penetrates the cover flange 11. In the state in which the pop bolt 13 is inserted into the gripper 3, the gripper 3 is fixed in the state in which the gripper 3 compresses the cover flange 11 against the lateral surface of the sub-pack casing 1 by a gripper locking nut 15 fastened to the pop bolt 13.

Therefore, the two opposite ends of the upper cover 5 of the sub-battery pack SBP are securely compressed against the lateral surface of the sub-pack casing 1 by the grippers 3, such that rattle noise or the like caused by vibration of the upper cover 5 is effectively suppressed while the vehicle travels.

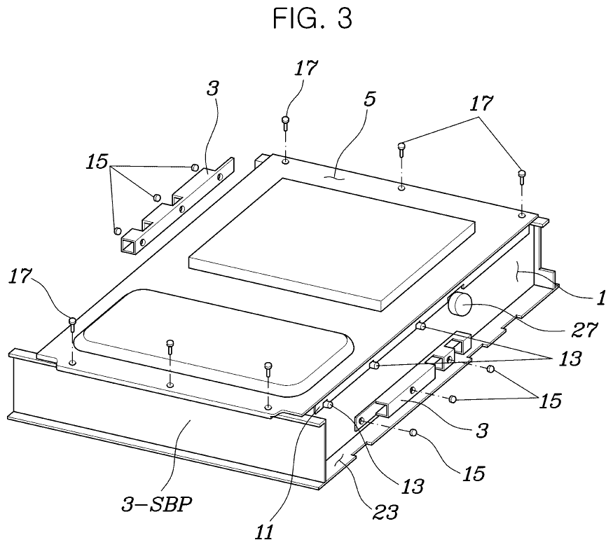

For reference, in the example in FIG. 3, the cover flanges 11 of the two opposite surfaces of the upper cover 5 are fixed to the two opposite surfaces of the sub-pack casing 1 by the pop bolts 13 and the gripper locking nuts 15. Front and rear ends of the upper cover 5 are securely fixed to the sub-pack casing 1 by cover locking bolts 17 fastened in an upward/downward direction.

The gripper 3 is mounted on the lateral surface of the sub-pack casing 1 and elongated in a horizontal direction of the sub-pack casing 1.

Holder insertion holes 19 are formed in the gripper 3, and the holding device 7 configured to hold and move the sub-battery pack SBP is inserted into the holder insertion holes 19.

In addition, tool insertion grooves 21 may be formed in the gripper 3 while avoiding the portions penetrated by the pop bolts 13, and a tool may pass through the tool insertion grooves 21 in the upward/downward direction of the gripper 3.

That is, the gripper 3 has the portion penetrated by the pop bolt 13 to fix the gripper 3 to the sub-pack casing 1, the portion having the holder insertion hole 19, and the portion having the tool insertion groove 21. These portions are disposed in the longitudinal direction of the gripper 3 without overlapping one another.

Meanwhile, in the present embodiment, sub-pack flanges 23 are provided on the two opposite surfaces of the sub-pack casing 1, such that the sub-pack flange 23 is coupled directly to the lower casing 9 or coupled indirectly to the lower casing 9 by an intermediate support 25 and constitutes the battery pack BP.

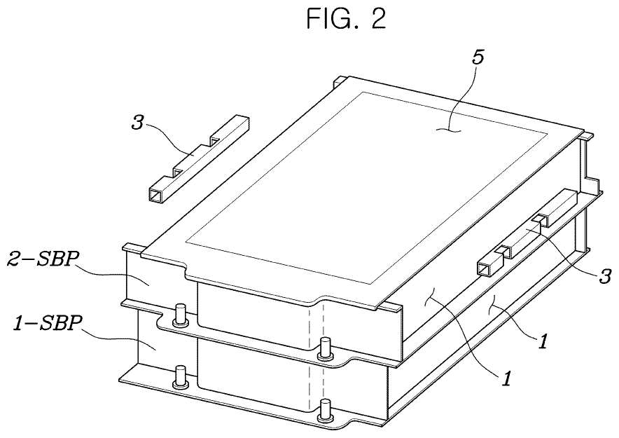

For example, as illustrated in FIGS. 2, 5, 6, and 7, the first layer sub-battery pack 1-SBP and the second layer sub-battery pack 2-SBP are coupled in a state in which the sub-pack flanges 23 thereof are in surface contact with one another, such that the first layer sub-battery pack 1-SBP and the second layer sub-battery pack 2-SBP are coupled directly to the lower casing 9. The third layer sub-battery pack 3-SBP is fixed indirectly to the lower casing 9 by means of the intermediate support 25 in FIG. 1.

As described above, the tool insertion groove 21 is formed in the gripper 3 in order to ensure a movement route for the tool used to couple the sub-pack flange 23 of the sub-battery pack SBP to the lower casing 9 or the intermediate support 25.

The grippers 3 may be mounted symmetrically on the two opposite surfaces of the sub-battery pack SBP and mounted at a center based on the horizontal longitudinal direction.

In addition, the grippers 3 may be asymmetrically mounted at the two opposite surfaces of the sub-battery pack SBP while avoiding a venting valve 27 or a busbar 29 provided on the lateral surface of the sub-battery pack SBP.

The sub-battery packs SBP may overlap one another in the upward/downward direction, as described above. In case that the first layer sub-battery pack 1-SBP, which is positioned at the lowermost side, and the second layer sub-battery pack 2-SBP, which overlaps the upper side of the first layer sub-battery pack 1-SBP, are coupled to each other in the upward/downward direction, the gripper 3 may be mounted only on the lateral surface of the second layer sub-battery pack 2-SBP.

In the present embodiment, the grippers 3, which are mounted on the lateral surface of the second layer sub-battery pack 2-SBP as described above, are mounted on the two opposite surfaces of the second layer sub-battery pack 2-SBP and mounted symmetrically at the center based on the horizontal longitudinal direction. The third layer sub-battery pack 3-SBP overlaps the upper side of the second layer sub-battery pack 2-SBP. The grippers 3 mounted on the lateral surface of the third layer sub-battery pack 3-SBP are asymmetrically mounted on the two opposite surfaces of the third layer sub-battery pack 3-SBP while avoiding the venting valve 27 or the busbar 29 provided on the lateral surface of the third layer sub-battery pack 3-SBP.

According to the present disclosure described above, the plurality of sub-battery packs SBP, which constitutes the battery pack BP, may be easily and stably assembled to the lower casing 9 by using the grippers 3.

In addition, the gripper 3, which is mounted by the above-mentioned structure, effectively prevent rattle noise by suppressing vibration of the upper cover 5 of the sub-battery pack SBP while the vehicle travels.

The present disclosure may also be expressed as follows.

That is, the battery pack BP of the present disclosure includes the lower casing 9 opened upward to accommodate the plurality of sub-battery packs SBP, the plurality of sub-battery packs SBP stacked on the lower casing 9 from above, and the grippers 3 mounted to protrude from the two opposite surfaces of the sub-pack casing 1 that face each other and define the external appearance of the sub-battery pack SBP.

Among the sub-battery packs SBP, the first layer sub-battery pack 1-SBP, which is provided at the lowermost side, and the second layer sub-battery pack 2-SBP, which overlaps the upper side of the first layer sub-battery pack 1-SBP, are coupled in the upward/downward direction and loaded into the lower casing 9, and the gripper 3 may be mounted only on the sub-pack casing 1 of the second layer sub-battery pack 2-SBP.

In case that the third layer sub-battery pack 3-SBP overlaps the upper side of the second layer sub-battery pack 2-SBP, the gripper 3 may also be mounted on the sub-pack casing 1 of the third layer sub-battery pack 3-SBP.

The gripper 3 is mounted on the lateral surface of the sub-pack casing 1 and elongated in a horizontal direction of the sub-pack casing 1.

The upper cover 5 of the sub-pack casing 1 has a cover flange 11 having two opposite ends bent downward. The gripper 3 is mounted in the state in which the gripper 3 compresses the cover flange 11 against the lateral surface of the sub-pack casing 1.

The pop bolt 13, which protrudes while penetrating the cover flange 11, is provided on the lateral surface of the sub-pack casing 1, and the mounting hole penetrated by the pop bolt 13 is formed in the gripper 3. The gripper locking nut 15 is fastened to the pop bolt 13 so that the gripper 3 compresses the cover flange 11 against the lateral surface of the sub-pack casing 1.

The tool insertion grooves 21 may be formed in the gripper 3 while avoiding the portions penetrated by the pop bolts 13, and the tool may pass through the tool insertion grooves 21 in the upward/downward direction of the gripper 3.

The holder insertion hole 19 is formed in the gripper 3 while avoiding the portion penetrated by the pop bolt 13 and the portion having the tool insertion groove 21, and the holding device 7 configured to hold and move the sub-battery pack SBP is inserted into the holder insertion hole 19.

While the specific embodiments of the present disclosure have been illustrated and described, it will be obvious to those skilled in the art that the present disclosure may be variously modified and changed without departing from the technical spirit of the present disclosure defined in the appended claims.

What is claimed is:

1. A sub-battery pack structure comprising:
a sub-pack casing configured to form an external appearance of a sub-battery pack; and
grippers mounted to protrude from two opposite surfaces of the sub-pack casing that face each other.

2. The sub-battery pack structure of claim 1, wherein each of the grippers is mounted on a lateral surface of the sub-pack casing and elongated in a horizontal direction of the sub-pack casing.

3. The sub-battery pack structure of claim 1, wherein each of the grippers has a holder insertion hole into which a holding device configured to hold and move the sub-battery pack is inserted.

4. The sub-battery pack structure of claim 1, wherein each of the grippers is mounted on the sub-pack casing in a state in which the gripper compresses a part of an upper cover of the sub-pack casing against a lateral surface of the sub-pack casing.

5. The sub-battery pack structure of claim 4, wherein the upper cover of the sub-pack casing has a cover flange having two opposite ends bent downward, and
wherein each of the grippers is mounted in the state in which the gripper compresses the cover flange against the lateral surface of the sub-pack casing.

6. The sub-battery pack structure of claim 5, wherein a pop bolt, which protrudes while penetrating the cover flange, is provided on the lateral surface of the sub-pack casing, and
wherein each of the grippers is inserted into the pop bolt and fixed in the state in which each gripper compresses the cover flange against the lateral surface of the sub-pack casing by a gripper locking nut fastened to the pop bolt.

7. The sub-battery pack structure of claim 6, wherein a tool insertion groove, which allows a tool to pass therethrough in an upward/downward direction of each gripper, is formed in each the grippers while avoiding a portion penetrated by the pop bolt.

8. The sub-battery pack structure of claim 2, wherein the grippers are mounted on two opposite surfaces of the sub-battery pack and mounted symmetrically at a center based on a horizontal longitudinal direction.

9. The sub-battery pack structure of claim 2, wherein the grippers are asymmetrically mounted on two opposite surfaces of the sub-battery pack while avoiding a venting valve or a busbar provided on the lateral surface of the sub-battery pack.

10. A battery pack comprising:
a lower casing opened upward to accommodate a plurality of sub-battery packs;
a plurality of sub-battery packs stacked on the lower casing from above, each sub-battery pack including a sub-pack casing configured to form an external appearance of the sub-battery pack; and
grippers mounted to protrude from two opposite surfaces of at least one sub-pack casing among the plurality of sub-battery packs, the two opposite surfaces facing each other.

11. The battery pack of claim 10, wherein among the sub-battery packs, a first layer sub-battery pack, which is provided at a lowermost side, and a second layer sub-battery pack, which overlaps an upper side of the first layer sub-battery pack, are coupled to each other in an upward/downward direction and loaded into the lower casing, and the grippers are mounted on the sub-pack casing of the second layer sub-battery pack but not on the first layer sub-battery pack.

12. The battery pack of claim 11, wherein the grippers are also mounted on a sub-pack casing of a third layer sub-battery pack when the third layer sub-battery pack overlaps an upper side of the second layer sub-battery pack.

13. The battery pack of claim 12, wherein each of the grippers is mounted on a lateral surface of the sub-pack casing and elongated in a horizontal direction of the sub-pack casing.

14. The battery pack of claim 13, wherein an upper cover of the sub-pack casing has a cover flange having two opposite ends bent downward, and
wherein each of the grippers is mounted in a state in which each gripper compresses the cover flange against the lateral surface of the sub-pack casing.

15. The battery pack of claim 14, wherein a pop bolt, which protrudes while penetrating the cover flange, is provided on the lateral surface of the sub-pack casing,
wherein a mounting hole penetrated by the pop bolt is formed in each of the grippers, and
wherein a gripper locking nut is fastened to the pop bolt so that each of the grippers compresses the cover flange against the lateral surface of the sub-pack casing.

16. The battery pack of claim 15, wherein a tool insertion groove, which allows a tool to pass therethrough in an upward/downward direction of each gripper, is formed in each of the grippers while avoiding a portion penetrated by the pop bolt.

17. The battery pack of claim 16, wherein a holder insertion hole is formed in each of the grippers while avoiding the portion penetrated by the pop bolt and a portion having the tool insertion groove, and a holding device configured to hold and move the sub-battery pack is inserted into the holder insertion hole.

18. The battery pack of claim 10, wherein the sub-battery packs overlap one another in an upward/downward direction, and wherein the grippers are mounted only on a lateral surface of a second layer sub-battery pack when a first layer sub-battery pack, which is positioned at a lowermost side, and the second layer sub-battery pack, which overlaps an upper side of the first layer sub-battery pack, are coupled to each other in the upward/downward direction.

19. The battery pack of claim 18, wherein the second layer sub-battery pack has a pair of grippers that are mounted on two opposite side surfaces and are disposed symmetrically based on a horizontal longitudinal direction, wherein a third layer sub-battery pack overlaps an upper side of the second layer sub-battery pack, and wherein the third layer sub-battery pack includes a pair of grippers that are mounted on two opposite side surfaces asymmetrically to avoid a venting valve or a busbar provided on the lateral surface of the third layer sub-battery pack.

20. A battery pack comprising:
a lower casing opened upward to accommodate a plurality of sub-battery packs;
a plurality of sub-battery packs stacked on the lower casing from above; and
grippers mounted to protrude from two opposite surfaces of a sub-pack casing, the two opposite surfaces facing each other, wherein the sub-pack casing forms an external appearance of the sub-battery pack;
wherein among the sub-battery packs, a first layer sub-battery pack, which is provided at a lowermost side, and a second layer sub-battery pack, which overlaps an upper side of the first layer sub-battery pack, are coupled to each other in an upward/downward direction and loaded into the lower casing, and each of the grippers is mounted only on the sub-pack casing of the second layer sub-battery pack;
wherein each of the grippers is mounted on a lateral surface of the sub-pack casing and elongated in a horizontal direction of the sub-pack casing, and an upper cover of the sub-pack casing has a cover flange having two opposite ends bent downward, and each of the grippers is mounted in the state in which each gripper compresses the cover flange against the lateral surface of the sub-pack casing.
